(19) United States
(12) Patent Application Publication
(10) Pub. No.: US 2009/0303257 A1
(43) Pub. Date: Dec. 10, 2009

(54) MOBILE TERMINAL DEVICE AND DISPLAY CONTROL METHOD

(75) Inventor: Takako YAMAGUCHI, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/478,795

(22) Filed: Jun. 5, 2009

(30) Foreign Application Priority Data
Jun. 5, 2008 (JP) 2008-147515

(51) Int. Cl. G09G 5/00

(52) U.S. Cl. 345/667

(57) ABSTRACT

A mobile terminal device includes a display unit, a display control unit and a display size determination unit. The display control unit controls a list display displayed in a list display area of the display unit and a preview display displayed in a preview display area of the display unit. The display size determination unit determines a ratio of display sizes of the list display area to the preview display area based on an amount of data for the preview display.

### CROSS-REFERENCE TO RELATED APPLICATIONS

This application is based upon and claims the benefit of priority of the prior Japanese Patent Application No. 2008-147515, filed on Jun. 5, 2008, the whole contents of which are incorporated herein by reference.

### BACKGROUND

1. Field

Embodiments of the present invention relate to a technique for performing a list display and a preview display on a mobile terminal device.

2. Description of Related Art

In recent years, mobile terminal devices have been widely used as mobile phones, Personal Digital Assistants (PDAs) and the like provided with, for example, an electronic mail transmission and reception function. Electrocnic mail is hereafter referred to as mail. Such a mobile terminal device has functions for performing a list display of transmitted and received mails and for performing a preview display of main text of a specified mail (see, for example, Japanese Laid-Open Publication No. 2004-310565). When a list of the mails is displayed in a display unit, the main text is preview-displayed in a given part of the display unit as a preview display area. Providing a list display and a preview display in the same screen in this manner allows a user to easily grasp the contents of the mails displayed in the list. Conventionally, when the entirety of the main text cannot be displayed in the preview display area because the main text is too long, the user displays the entirely of the main text by scrolling in the preview display area.

In the mobile terminal device, the display unit is generally small, and the list display and the preview display are performed within a limited display area. Consequently, a size of the preview display area may be much smaller than a size required for the entirety of the main text of the mail, and only a limited portion of the main text may be displayed in the preview display area. In this case, visibility of the preview display is reduced, and it is difficult for the user to grasp the content of the mail. Furthermore, in this case, the user typically scrolls down a large amount to view the entirety of the main text of the mail. Having to scroll down may be troublesome or inconvenient to the user.

It may be considered to improve user's visibility and to reduce user's operational burden by setting the preview display area to be large beforehand. In this manner, however, a listing property of the list display may be reduced because generally a small area is allocated to the list display area. Furthermore, in this manner, there is an empty area in the preview display area when the main text of the mail is short resulting in the display unit not being used effectively.

### SUMMARY

According to an aspect of the embodiment discussed herein, a mobile terminal device includes a display unit to display a list display and a preview display, a display control unit to control the list display displayed in a list display area of the display unit and the preview display displayed in a preview display area of the display unit, and a display size determination unit to determine a ratio of display sizes of the list display area to the preview display area based on an amount of data for the preview display.

The mobile terminal device may also include a storage unit storing at least one display parameter, and a display screen forming unit to form a display screen by using the data for the preview display and the at least one display parameter. The display size determination unit may determine the ratio of the display sizes based on the display screen. Further, the display size determination unit variably adjusts the determined ratio of display sizes when the amount of data for the preview display changes or a stored display parameter changes.

Additional objects and advantages of the embodiment will be set forth in part in the description which follows, and in part will be understood from the description, or may be learned by practice of the embodiment. The object and advantages of the embodiment will be realized and attained by means of the elements and combinations particularly pointed out in the appended claims.

It is to be understood that both the foregoing summary description and the following detailed description are exemplary and explanatory and are not restrictive of the embodiment, as claimed.

### BRIEF DESCRIPTION OF DRAWINGS

FIG. 1 is an appearance diagram illustrating a display unit of a mobile phone as an embodiment of the disclosed mobile terminal device,

FIG. 2 is a functional block diagram illustrating a configuration of the mobile phone of FIG. 1,

FIG. 3 is a flowchart illustrating displaying control processing in the mobile phone of FIG. 1,

FIGS. 4A and 4B are diagrams illustrating an example of a display screen of the mobile phone of FIG. 1,

FIGS. 5A to 5C are diagrams illustrating another example of the display screen of the mobile phone of FIG. 1, and

FIG. 6 is a diagram illustrating the display screen of a conventional mobile phone.

### DESCRIPTION OF EXAMPLES OF EMBODIMENTS

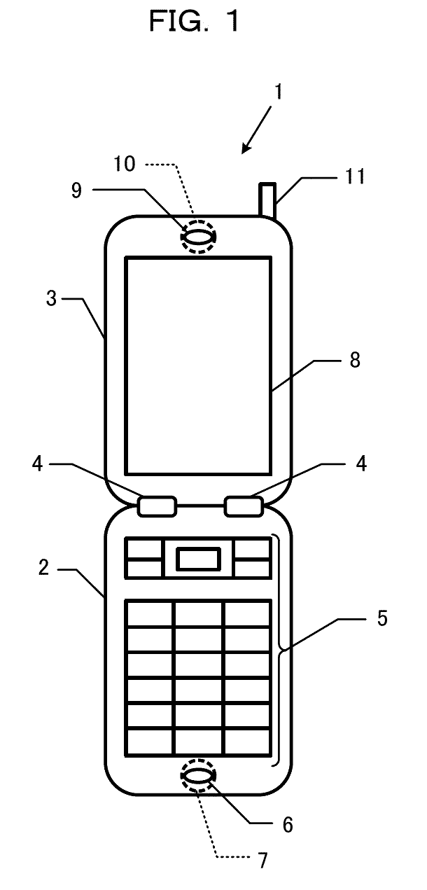

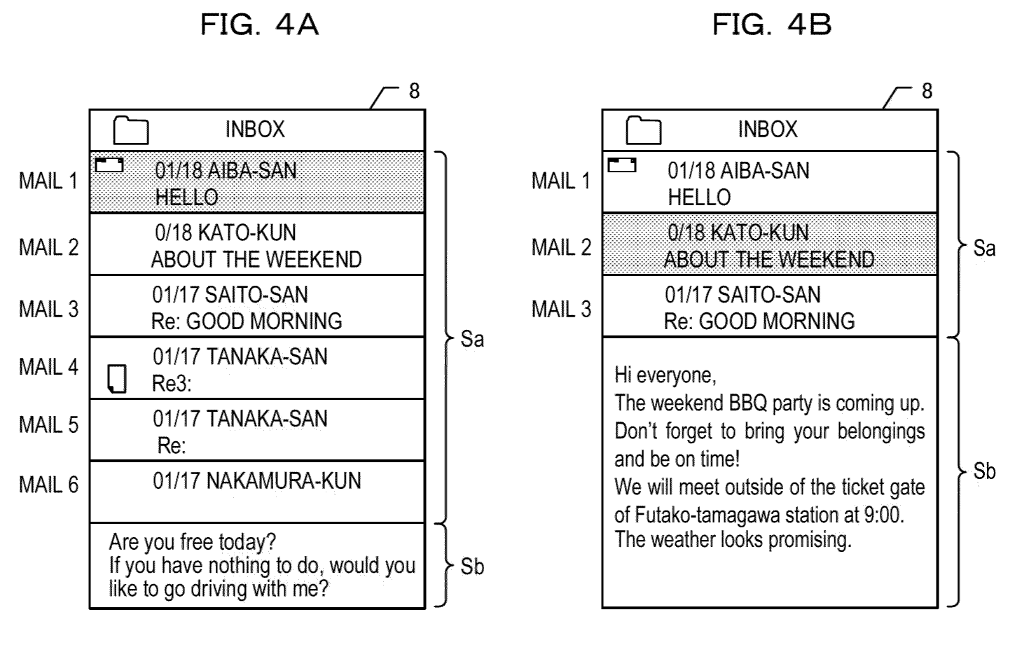

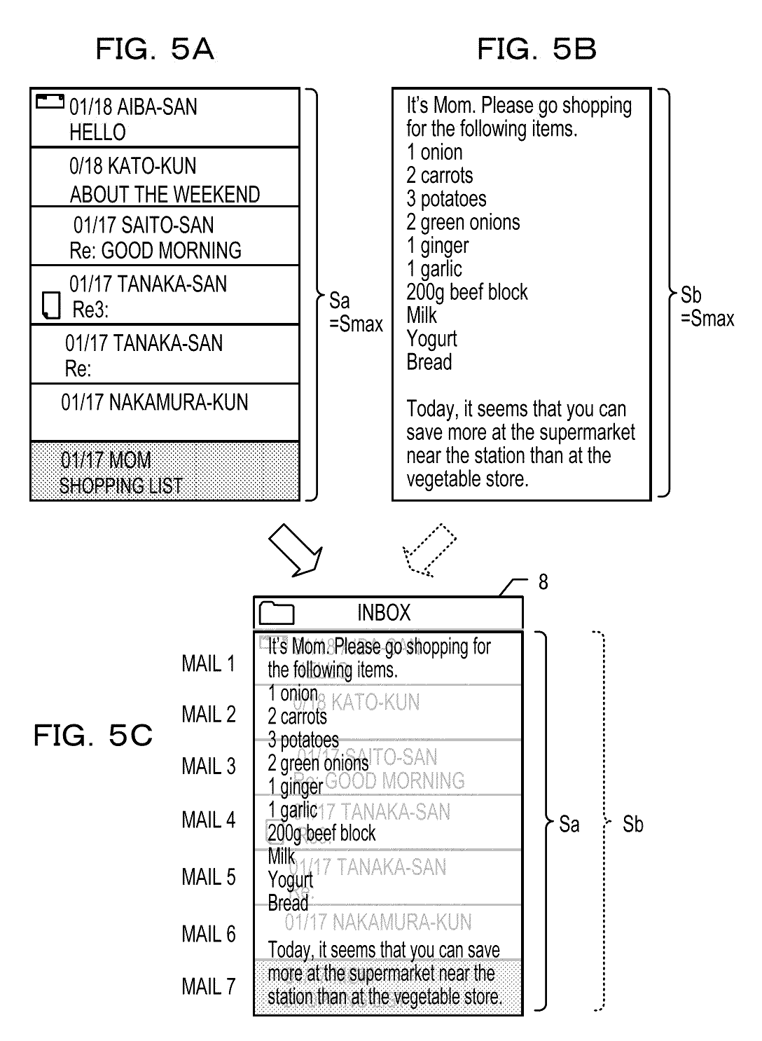

With reference to FIG. 1 to FIG. 6, description will be made of a mobile phone 1 as an embodiment of the above-described mobile terminal device. The mobile phone 1 may include a telephone function, a mail transmission and reception function and the like by radio communication with an external center, for example. The mobile phone 1 may also include functions for performing a list display of transmitted and received mails and performing a preview display of the main text of a specified mail while a list is being displayed in the list display (see FIGS. 4A and 4B and FIGS. 5A to 5C, described below).

As illustrated in FIG. 1, the mobile phone 1 includes a fixed unit 2 and a movable unit 3 connected by a hinge unit 4 so that the mobile phone 1 may be disposed in an open state and closed state. FIG. 1 illustrations the open state of the mobile phone 1. An operation input unit 5 and a mouthpiece 6 are allocated on the front surface of the fixed unit 2. A microphone 7 is allocated inside of the mouthpiece 6. In the operation input unit 5, for example, a menu key, an application selection key, a scroll key, a power source key, an execution key, a clear key, a cursor key, a dial/character key and the like are allocated as a plurality of key switches. Those key switches are used, for example, when a user specifies a mail from the list or when a user scrolls the main text of the mail.

Furthermore, a display unit 8 and an earpiece 9 are allocated on the front surface of the movable unit 3. A speaker 10 is allocated inside of the earpiece 9. The display unit 8 includes a Liquid Crystal Display (LCD) and the like, and is used for cursor display and the like for information presentation and information selection. Furthermore, an antenna 11 may be provided on the back surface of the movable unit 3.

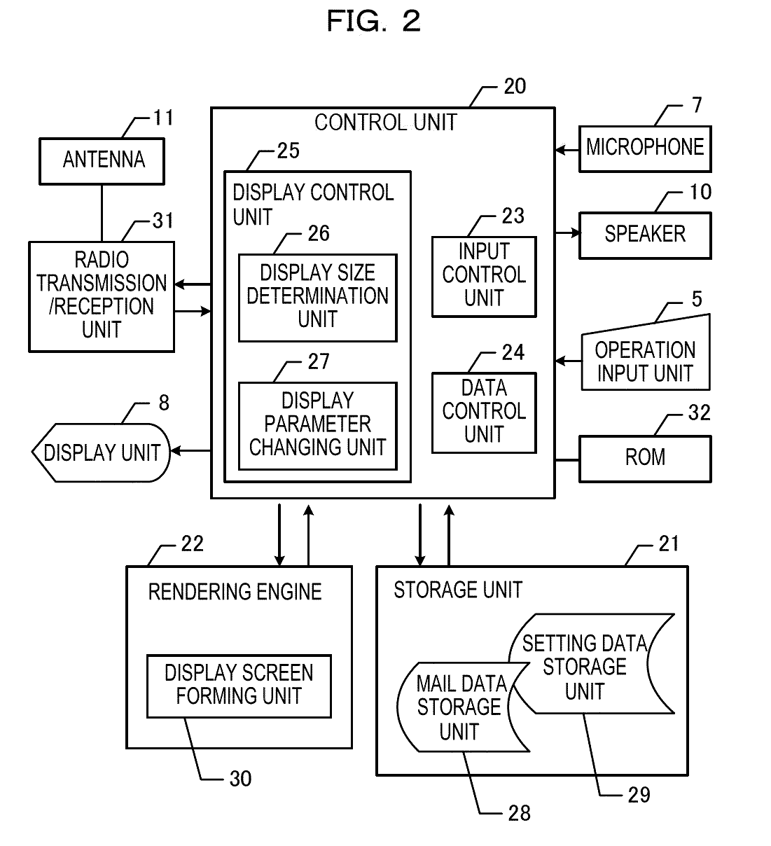

The mobile phone 1 has an electronic unit that includes a Central Processing Unit (CPU) (not shown), a memory (a storage unit 21 and a Read Only Memory (ROM) 32) and the like. The mobile phone 1 also includes a control unit 20, a storage unit 21, and an rendering engine 22 as described in FIG. 2, for example. Furthermore, the control unit 20 is connected to the operation input unit 5, the display unit 8, the microphone 7, and the speaker 10. Moreover, the control unit 20 is connected to the antenna 11 through a radio transmission/reception unit 31. The radio transmission/reception unit 31 includes a radio unit that transmits and receives high frequency signals and a signal processing unit that performs signal processing of voice and data. The radio transmission/reception unit 31 performs radio transmission and reception of signals, which may relate to telephone communications or mail, with a provider, base station or other telephones, for example.

The storage unit 21 includes a mail data storage unit 28 that stores data of transmitted and received mails and a setting data storage unit 29 that stores setting data used for various functions of the mobile phone 1. The setting data includes display parameters to display a mail in the display unit 8. The display parameters includes, for example, the maximum size of the display area of the display unit 8, the maximum size of the preview display area, a character font, a character size, a character pitch, a line pitch and the like.

The rendering engine 22 has a function for rendering the data by using one or more display parameters and includes a display screen forming unit 30 that forms a display screen for displaying on the display unit 8. In this case, “Rendering” refers to imaging of information, given as data, by calculation. When a mail for the preview display is specified at the time of displaying a list of mails, the display screen forming unit 30 renders the main text of the specified mail by using the mail data stored in the mail data storage unit 28 and the display parameters stored in the setting data storage unit 29, and forms a display screen. The processing by the display screen forming unit 30 generally includes processing for forming a display screen internally by calculation, and does not include processing for actually displaying the formed screen on the display unit 8.

The control unit 20 performs various information processing such as call control and mail transmission and reception control. The control unit 20 includes an input control unit 23, a data control unit 24, and a display control unit 25. When a key switch of the operation input unit 5 is pressed, for example, the input control unit 23 receives the operation input to perform processing. The data control unit 24 performs writing/reading of the mail data and the setting data to/from the storage unit 21.

The display control unit 25 forms a display screen for displaying on the display unit 8 and displays the formed screen. The display control unit 25 performs the list display in the list display area of the display unit 8 and the preview display processing for performing the preview display in the preview display area of the display unit 8. Specifically, as for the preview display processing, the display control unit 25 displays the list of the data (e.g., the transmitted and received mails) in the list display area of the display unit 8 and displays the preview of the content of specified data (e.g., the main text of the mail specified from the transmitted and received mails) in the preview display area of the display unit 8.

The functions of the control unit 20 and the rendering engine 22 are achieved by the CPU (e.g., a computer used to execute a program stored in a memory, which causes the computer to perform operations of the disclosed display method), provided in the mobile phone 1.

Furthermore, the display control unit 25 includes a display size determination unit 26 that determines a ratio of display sizes of the of the list display area to the preview display area. The ratio is determined based on a data amount (e.g., a data amount of the main text of the specified mail) for the preview display. As for the data amount of the main text of the mail, for example, the number of characters of the main text, the size desired to display the entirety of the main text (for example, the number of lines, areas and the like) are used. The data amount of the main text of the mail is reflected on the display screen formed by the display screen forming unit 30 by using the data of the main text of the mail.

Specifically, the display size determination unit 26 calculates the size desired to display the entirety of the main text of the mail based on the display screen formed by the display screen forming unit 30. Then the display size determination unit 26 determines whether the calculated size is substantially equal to or greater than the maximum size of the preview display area of the display unit 8 (e.g., substantially the same value as the maximum size of the display area of the display unit 8). The maximum size has, for example, a given value as a specification of the display unit 8. When the calculated size is determined to be less than the maximum size, the display size determination unit 26 determines the calculated size as the size of the preview display area and determines the size of the list display area as the size of the display area other than the preview display area. Consequently, the ratio of the display sizes of the list display area to the preview display area is determined.

When the calculated size is determined to be equal to or greater that the maximum size, the display size determination unit 26 determines the maximum size of the display area of the display unit 8 as both of the sizes of the list display area and the preview display area. Consequently, the ratio of display sizes of the list display area to the preview display area is determined. Then the display control unit 25 superposes the list display of the list of the mails and the preview display of the main text of the specified mail as visually distinguished from each other. The display control unit 25 displays the main text of the mail in a translucent state and the list of the mails in a opaque state as visually distinguished from each other.

Furthermore, the display control unit 25 includes a display parameter changing unit 27 that changes the setting of display parameters. Based on the display screen formed by the display screen forming unit 30, by using the display parameters changed by the display parameter changing unit 27, the display size determination unit 26 determines the ratio of the display sizes of the list display area to the preview display area, which is used by the display control unit 25.

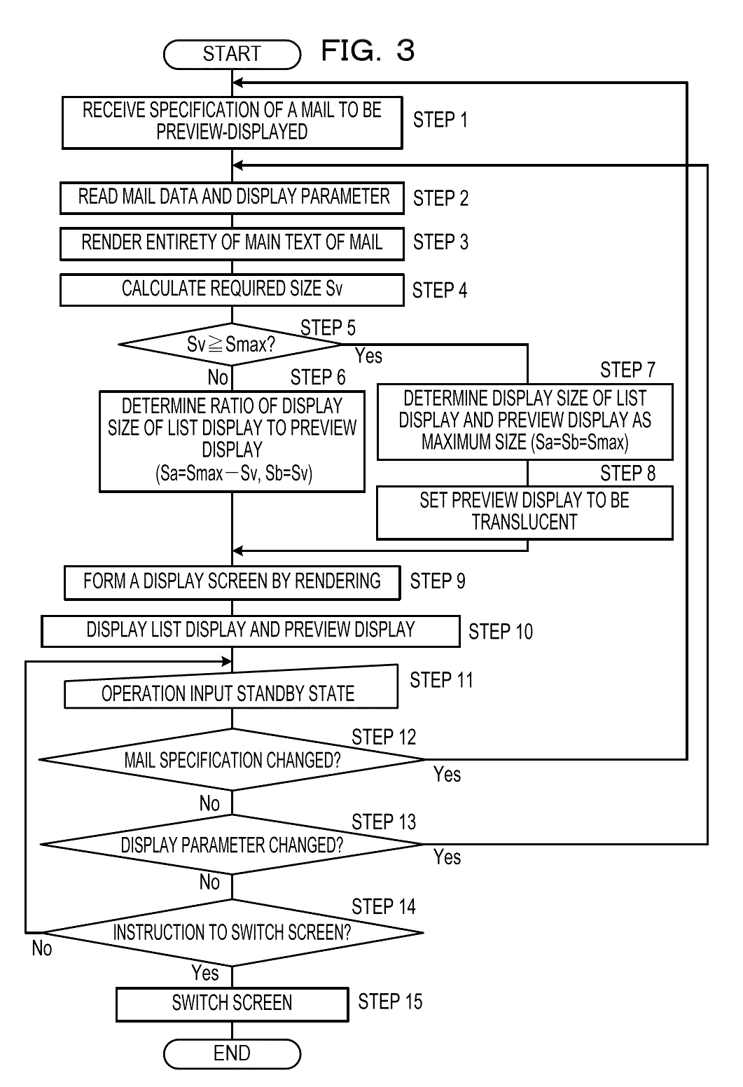

Next, a description is provided of operations (e.g., preview display processing) of the mobile phone 1 of the present embodiment with reference to the flowchart in FIG. 3. In the initial state, the mobile phone 1 is in a power-ON state, and the display unit 8 displays a mail list display screen. In the mail list display screen, the list of transmitted and received mails is list-displayed in the list display area of the display unit 8, and the main text of the mail specified from the transmitted and received mails is preview-displayed in the preview display area of the display unit 8.

With reference to FIG. 3, in STEP 1, the key switch of the operation input unit 5 is pressed by a user to perform the operation input to specify the mail for the preview display, and the input control unit 23 receives this operation input. Specifically, for example, the focus of the list-displayed mails may be navigated by using a scroll key or a cursor key, and then a desired mail is selected. In this manner, the selected mail is specified.

Next, in STEP 2, the data control unit 24 reads the data of the specified mail from the mail data storage unit 28 and reads the display parameters from the setting data storage unit 29.

Next, in STEP 3, the display screen forming unit 30 renders the data of the specified mail by using the display parameters and forms a display screen for the case in which the entirety of main text of the mail is displayed. Specifically, the display screen forming unit 30 inputs the read mail data and the read display parameters, and then renders the mail data by using the display parameters. At this time, for example, the display screen forming unit 30 renders the mail data as if the size of the preview display area is large enough to display the entirety of the main text of the mail. Accordingly the display screen is obtained in case of assuming that the entirety of the main text of the specified mail is displayed. The size of the display screen obtained as a result of the rendering depends on the data amount of the main text of the specified mail. Therefore, in STEPs 4 to 7 described below, by determining the size of the list display area and the size of the preview display area depending on the result of the rendering, the ratio of the display sizes of the list display area to the preview display area may be determined based on the data amount of the main text of the mail for the preview display.

Next, in STEP 4, the display size determination unit 26 calculates a size Sv (for example, a required number of lines) to be used to display the entirety of the main text of the mail based on the display screen obtained as the result of the rendering by the display screen forming unit 30. At this time, for the data of the specified mail, by calculating the required size Sv based on the display screen, the required size to be actually displayed in the display unit 8 may be properly calculated, reflecting the display parameters. Thus, in STEPs 5 to 7 described below, by determining the ratio of the display sizes of the list display area to the preview display area based on the required size Sv, the ratio may be properly determined in such a way that the display size matches the actual display. As described above, by determining the ratio of the display sizes of the list display area to the preview display area based on the display screen formed by the display screen forming unit 30, the ratio may be determined in such a way that the display size matches the actual display, and the display unit 8 may be used effectively.

Next, in STEP 5, the display size determination unit 26 determines whether or not the required size Sv calculated in STEP 4 is greater than or equal to the maximum size Smax of the display area of the display unit 8.

If the determination result is NO in STEP 5 (i.e., the calculated required size Sv is less than the maximum size Smax), the entirety of the main text of the mail can be preview-displayed as is (see FIGS. 4A and 4B, described below). In this case, the process goes to STEP 6. The display control unit 25 determines the required size Sv calculated in STEP 4 as the size Sb of the preview display area, and determines the size of the rest of the display area (e.g., the size obtained by subtracting the size Sv from the maximum size Smax) as a size Sa (Sa=Smax-Sv, Sb=Sv). The preview display area is determined to be the size Sv. Therefore, in STEP 10 described below, the entirety of the main text of the mail is preview-displayed, so that user's visibility may be improved and user's burden relating to a scrolling operation may be reduced. The list display area is determined to be the size Smax-Sv of the rest of the display area by reflecting the data amount of the main text of the mail to be preview-displayed. Thus, in STEP 10 described below, as many mails as possible are list-displayed in the rest of the display area, so that the listing property of the list display may be maintained.

On the other hand, if the determination result in STEP 5 is YES (the calculated required size Sv is greater than or equal to the maximum size Smax), the list may not be list-displayed when the entirety of the main text of the mail is preview-displayed as is (see FIGS. 5A to 5C, described below). In this case, the process goes to STEP 7. The display size determination unit 26 determines the size Sa of the list display area and the size Sb of the preview display area to be the maximum size Smax, respectively (Sa=Sb=Smax). Next, in STEP 8, the display control unit 25 sets a display parameter (the display parameter indicating whether or not the preview display is translucent) in such a way that the preview display is performed in a translucent state. In STEPs 7 to 8, the preview display area is determined to be the maximum size Smax. Therefore, in STEP 10 described below, the main text of the mail is preview-displayed in a large size, so that user's visibility may be improved and user's burden relating to a scrolling operation, for example, may be reduced. Then the list display area is also determined to be the maximum size Smax, and the display parameter is set in such a way that the preview display is performed in a translucent state to be visually distinguished from the list display. Thus, in STEP 10 described below, many mails are list-displayed, so that the listing property of the list display may be maintained.

Next, in STEP 9, the display screen forming unit 30 forms a display screen by using the determined size Sa of the list display area and the determined size Sb of the preview display area. Specifically, the display screen forming unit 30 inputs the determined sizes Sa and Sb, and the display parameter, which indicates whether or not the list display is translucent with other display parameters and other mail data. Then the display screen forming unit 30 renders the mail data by using the display parameters to generate a display screen to be displayed in the display unit 8.

Next, in STEP 10, the display control unit 25 displays the display screen, generated by the display screen forming unit 30, in the display unit 8. Consequently, the display unit 8 performs the list display of the mails and the preview display of the main text of the specified mail. At this time, since the sizes Sa and Sb are determined based on the data amount of the main text in STEPs 4 to 7, the preview display and the list display may be performed, as illustrated in FIGS. 4A and 4B and FIGS. 5A to 5C described below, by effectively using the display unit 8. The sizes Sa and Sb to be used for the list display and the preview display are determined sequentially without processing other operations. For example, only the sizes Sa and Sb and related process may be performed to change the preview display.

Next, in STEP 11, the mobile phone 1 is in an output standby state in which the mobile phone 1 is waiting for input from the operation input unit 5, and the input control unit 23 determines whether or not the operation input is performed. STEP 11 is repeated until the operation input is determined to be performed. If the operation input is performed in STEP 11, the input control unit 23 receives the operation input from the operation input unit 5.

Next, in STEP 12, the input control unit 23 determines whether or not the operation input received in STEP 11 changes the specification of the mail to be preview-displayed, that is, whether or not there has been a change regarding which mail is selected. If the determination result in STEP 12 is YES (i.e., a different mail has been selected and thus the specified mail has changed), the process goes back to STEP 1. The processing of STEP 1 to STEP 11 is then repeated.

If the determination result in STEP 12 is NO (i.e., the specified mail has not changed), the process goes to STEP 13. The display control unit 25 determines whether or not the setting of a display parameter (for example, a character size) is changed. Specifically, in display parameter changing processing, in STEP 11, for example, the key switch of the operation input unit 5 is pressed by the user to perform operation input to change the display parameter. The input control unit 23 receives this operation input. The display parameter changing unit 27 changes the display parameter according to this operation input, and makes the setting data storage unit 29 store the display parameter that is changed by the data control unit 24. Consequently, the display parameter is changed. Then, the display control unit 25 determines that the display parameter is changed.

If the determination result in STEP 13 is YES (i.e., the display parameter is changed), the process goes back to STEP 2, and the processing of STEP 2 to STEP 11 is repeated. Consequently, when the setting of the display parameter is changed, rendering is performed in STEP 3 by using the changed display parameter. Based on the result of the rendering, the size Sa of the list display area and the size Sb of the preview display area are determined in STEPs 4 to 7. By using the determined sizes Sa and Sb, the list display and the preview display are performed in STEP 10. Therefore, when the user changes the display parameter, the display unit 8 is effectively used according to the changed display parameter. At this time, the sizes Sa and Sb to be used for the list display and the preview display are determined sequentially without processing other operations by changing the display parameter by the user. For example, only the display parameter may have been changed and only processes related to the change of the display parameter may be performed.

If the determination result in STEP 13 is NO (i.e., the display parameter is unchanged), the process goes to STEP 14. The input control unit 23 determines whether or not the input received in STEP 11 is the operation input instructing to switch from the mail list display screen to another screen. If the determination result in STEP 14 is NO (e.g., the input is not the operation input instructing to switch the screen), the process goes back to STEP 11. In step 11, the mobile phone 1 operates in the input standby state waiting for the operation input.

If the determination result in STEP 14 is YES (e.g., the input is the operation input instructing to switch the screen), the process goes to STEP 15. According to the received operation input, the display control unit 25 controls processes to switch from the mail list display screen to another screen in the display unit 8 and ends the preview display processing.

The preview display processing of the mobile phone 1 is described above. STEP 3 corresponds to an example of forming a display screen. Furthermore, STEPs 4 to STEP 7 correspond to an example of determining a display size.

Next, by using the display screen example illustrated in FIGS. 4A and 4B and FIGS. 5A to 5C, a detailed description of an example of a display screen of the display unit 8 of the mobile phone 1 is provided.

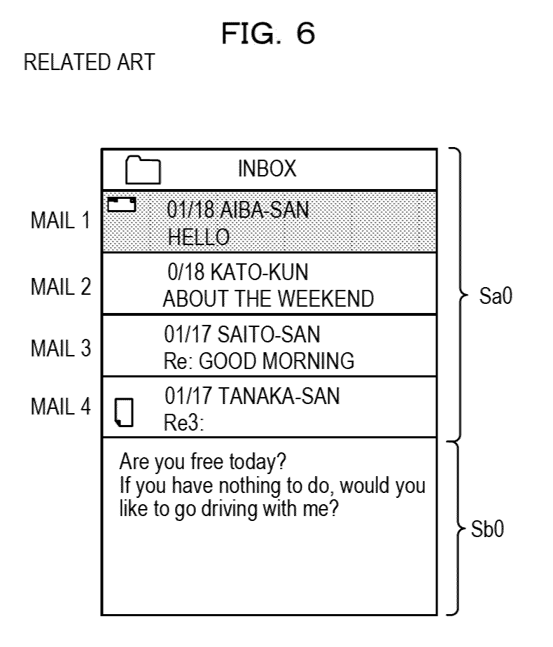

First, FIG. 6 illustrates a display screen example as a comparison example of related art. In FIG. 6, the size of the list display area and the size of the preview display area are fixed values, Sa0 (=eight lines), Sb0 (=six lines), which are provided in advance. In the example in FIG. 6, four mails (mails 1 to 4) are list-displayed in the list display area, and the main text of the mail 1 is preview-displayed in the preview display area. The example in FIG. 6 illustrates the case where the main text of the mail specified as the mail to be preview-displayed (e.g., the mail 1 in this example) is shorter than the preview display area. In the conventional display screen, the sizes Sa0 and Sb0 of the area are fixed. Thus, there is an empty area in the preview display area so that the display unit 8 is not used effectively.

Meanwhile, FIG. 4A illustrates a display screen example according to the preview display processing of the present embodiment. In the example of FIG. 4A, the mail to be preview-displayed is the mail 1.

In the display screen example in FIG. 4A, the input control unit 23 receives the operation input for specifying the mail 1 in STEP 1. In STEP3, the display screen forming unit 30 renders the mail 1. In STEP 4, the display size determination unit 26 calculates the size Sv to be “two lines,” required to display the entirety of the main text of the mail 1. Next, in STEP 5, the display size determination unit 26 determines that the size Sv is smaller than the maximum size Smax (e.g., =14 lines). In STEP 6, the display size determination unit 26 determines the size Sb of the preview display area to be “two lines” that is the same as the size Sv, and determines the size Sa of the list display area to be “10 lines”, obtained by subtracting the size Sv from the maximum size Smax. In STEP 10, the display control unit 25 performs the list display and the preview display by using the sizes Sa and Sb.

Consequently, as illustrated in FIG. 4A, six mails (the mails 1 to 6) are displayed in the list display area, and the entirety of the main text of the mail 1 is displayed in two lines in the preview display area. In such a case, if the main text of the mail is small (the data amount is small), the preview display area is small, and many mails may be list-displayed. Thus, the main text of the mail is preview-displayed, so that user's visibility may be improved and user's operational burden may be reduced. Moreover, since as many mails as possible are list-displayed in the rest of the display area, the listing property may be maintained.

Next, the display example in FIG. 4B illustrates the case where the main text of the mail specified as the mail to be preview-displayed is longer than the example illustrated in FIG. 4A.

In the display example in FIG. 4B, the input control unit 23 receives the operation input for specifying the mail 2 in STEP 1. In STEP 3, the display screen forming unit 30 renders the mail 2. In STEP 4, the display size determination unit 26 calculates the size Sv to be “eight lines”, required to display the entirety of the main text of the mail 2. Next, in STEP 5, the display size determination unit 26 determines that the size Sv is smaller than the maximum size Smax (=14 lines). In STEP 6, the display size determination unit 26 determines the size Sb of the preview display area to be “eight lines” that is the same as the size Sv, and determines the size Sa of the list display area to be “six lines” obtained by subtracting the size Sv from the maximum size Smax. Then, in STEP 10, the display control unit 25 performs the list display and the preview display by using the sizes Sa and Sb.

Consequently, as illustrated in FIG. 4B, three mails (the mails 1 to 3) are displayed in the list display area, and the entirety of the main text of the mail 2 is displayed in eight lines in the preview display area. In such a case, if the main text of the mail is long (the data amount is large), the preview display area becomes large so that the entirety of the main text is preview-displayed. Accordingly, the entirety of the main text of the mail is preview-displayed so that user's visibility may be improved and user's operational burden may be reduced. Moreover, since as many mails as possible are list-displayed in the rest of the display area, the listing property may be maintained.

Next, the display example in FIGS. 5A to 5C indicates the case where the main text of the mail specified to be preview-displayed (the mail 7 in this example) is longer than the example in FIG. 4B (the data amount is large) and where the size Sv required to display the main text of the mail is greater than or equal to the maximum size Smax.

In the display example in FIGS. 5A to 5C, the input control unit 23 receives specification input of the mail 7 in STEP 1. In STEP 3, the display screen forming unit 30 renders the mail 7. In STEP 4, the display size determination unit 26 calculates the size Sv to be “14 lines”, required to display the entirety of main text of the mail 7. Next, in STEP 5, the display size determination unit 26 determines the size Sv to be the maximum size (e.g., =14 lines) or more. In STEP 7, the size Sa of the list display area and the size Sb of the preview display area are set to be the maximum size Smax. In STEP 8, the display control unit 25 sets the preview display to be translucent. Then, In STEP 10, the display control unit 25 performs the list display and the preview display by using the sizes Sa and Sb.

Consequently, the list display in which the size Sa equals the maximum size Smax illustrated in FIG. 5A becomes non-transparent, and the preview display in which the size Sb equals the maximum size Smax illustrated in FIG. 5B becomes translucent. By superposing the preview display on the list display, the screen illustrated in FIG. 5C is displayed. FIGS. 5A to 5C illustrates the case where the size Sv of the main text of the mail 7 equals the maximum size Smax. For example, if the size Sv is larger than the maximum size Smax, the entirety of the main text may be displayed in the preview display area by a user's scrolling operation.

In this manner, when the main text is long and the size Sv for displaying the entirety of the mail is equal to or greater than the maximum size Smax of the display unit 8, the main text of the mail is preview-displayed in the maximum size Smax of the preview display area. Thus, user's visibility may be improved and user's operational burden may be reduced. Moreover, the list of the mails is displayed in the maximum size Smax by superposing the preview display that is translucent, in this case the list may be seen from the preview display under, and as many mails as possible are displayed therein, so that the listing property may be maintained.

According to the present embodiment, by using the display unit 8 effectively, it is possible to achieve the listing property of the list display of the mails and the visibility of the preview display of the main text of the mail.

In the present embodiment, the screen is a screen to display received mails. The screen may be a screen to display transmitted mail.

In the present embodiment, the mobile phone 1 has the transmission/reception function. Alternatively, the mobile phone 1 may have either the transmission function or the reception function.

In the present embodiment, the maximum size of the preview display area has the same value as the maximum size of the display area of the display unit 8. The maximum size of the preview display area may have the value that is smaller than the maximum size of the display area of display unit 8. For example, as another embodiment, the minimum size of the list display area is set, and the maximum size of the preview display area is obtained by subtracting the minimum size of the list display area from the maximum size of the display area of the display unit 8. Accordingly, the minimum size of the list display area is ensured. Thus, it is possible to determine the ratio of the display sizes of the list display area to the preview display area in such a way that at least a given number of mails corresponding to the minimum size are list-displayed. Moreover, a user may change the maximum size of the preview display area and the minimum size of the list display area as the display parameter.

Furthermore, in the present embodiment, the mobile phone 1 having the mail transmission and reception function displays the data to be displayed as a mail in the list of mails, and preview-displays the main text of the specified mail. The data to be displayed is not limited to mails. For example, the mobile phone 1 may have an image management function, may list-display image titles, thumbnails and the like of the data to be displayed as the images, and may preview-display the specified image itself. Furthermore, for example, the mobile phone 1 may have an address management function and may perform the list display and the preview display of the data to be displayed as an address. Furthermore, for example, the mobile phone 1 may have a schedule management function and perform the list display and the preview display of the data to be displayed as a schedule.

In the present embodiment, the mobile phone 1 is a mobile phone having a movable unit that is openable and closable by the hinge unit 4. The mobile phone 1 may be a sliding-type mobile phone having a movable unit capable of sliding or a straight-type mobile phone having a fixed unit.

In the present embodiment, to superimpose the preview display on the list display, the preview display is displayed in a translucent state and the list display is displayed in a non-transparent state. The list display may be displayed in a translucent state, and the preview display may be displayed in a non-transparent state. For example, the preview display and the list display may be displayed respectively in a visible state by different colors, fonts and the like.

In the present embodiment, specification of the mail to be preview-displayed is performed by selections made using the operation input unit 5. The specification of the mail to be preview-displayed may also be performed by, for example, voice input through the microphone 7.

In the present embodiment, a mobile phone is used as a mobile terminal device. Other devices such as PDAs may be used as a mobile terminal device.

According to the above-described mobile terminal device and preview display method, it is possible to achieve both the listing property of list display and the visibility of preview display by effectively using the display unit.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although embodiments have been described in detail, it should be understood that the various changes, substitutions, and alterations could be made hereto without departing from the spirit and scope of the invention.

What is claimed is:

1. A mobile terminal device comprising:
a display unit to display a list display and a preview display;
a display control unit to control the list display displayed in a list display area of the display unit and the preview display displayed in a preview display area of the display unit; and
a display size determination unit to determine a ratio of display sizes of the list display area to the preview display area based on an amount of data for the preview display.

2. The mobile terminal device according to claim 1 further comprising:
a storage unit storing at least one display parameter;
a display screen forming unit to form a display screen by using the data for the preview display and the at least one display parameter; and wherein
the display size determination unit determines the ratio of the display sizes based on the display screen.

3. The mobile terminal device according to claim 1, wherein the display size determination unit variably adjusts the determined ratio of display sizes when the amount of data for the preview display changes.

4. The mobile terminal device according to claim 2, wherein the display size determination unit variably adjusts the determined ratio when at least one of the amount of data for preview display and the at least one display parameter changes.

5. The mobile terminal device according to claim 2, wherein the display size determining unit
calculates a size required to display an entirety of the data for the preview display based on the formed display screen,
determines the size of the preview display area is the calculated size if the calculated size is less than a specified maximum size of the preview display area, and
determines a size of the list display area by subtracting the size of the preview display area from a size of a total display area of the display unit.

6. The mobile terminal device according to claim 2, wherein the display size determining unit
calculates a size required to display an entirety of the data for the preview display based on the formed display screen,
uses a size of a total display area of the display unit as both of the size of the list display area and the size preview display area when the calculated size is equal to or greater than a specified maximum size, and
superposes the list display and the preview display.

7. The mobile terminal device according to claim 6, wherein the list display and the preview display are superposed in a manner in which one of the list display and the preview display is translucent.

8. The mobile terminal device according to one of claim 2 further comprising:
a display parameter changing unit to change the at least one display parameter, and wherein
the display size determining unit determines the ratio based on the display screen formed by using the changed at least one display parameter.

9. A display control method implemented in a mobile terminal device including a display unit, the method comprising:
performing a list display in a list display area of the display unit and a preview display in a preview display area of the display unit;
receiving an amount of data for the preview display; and
determining a ratio of display sizes of the list display area to the preview display area based on the amount of data for the preview display.

10. The display control method according to claim 9, further comprising:
storing at least one display parameter in a storage unit;
forming a display screen using the data for the preview display and the at least one display parameter; and wherein
the determining determines the ratio of the display sizes based on the formed display screen.

11. The display control method according to claim 9, further comprising:
variably adjusting the determined ratio of display sizes when the amount of data for the preview display changes.

12. The display control method according to claim 10, further comprising:
receiving an input changing the at least one stored display parameter; and
variably adjusting the determined ratio when the at least one stored display parameter changes.

13. The display control method according to claim 10, wherein the determining includes:
calculating a size required to display an entirety of the data for the preview display based on the formed display screen;
determining the size of the preview display area is the calculated size if the calculated size is less than a specified maximum size of the preview display area; and
determining a size of the list display area by subtracting the size of the preview display area from a size of a total display area of the display unit.

14. The display control method according to claim 10, wherein the determining includes:
calculating a size required to display an entirety of the data for the preview display based on the formed display screen;
using a size of a total display area of the display unit as both of the size of the list display area and the size preview display area when the calculated size is equal to or greater than a specified maximum size; and
superposing the list display and the preview display.

15. The mobile terminal device according to claim 14, wherein the list display and the preview display are superposed in a manner in which one of the list display and the preview display is translucent.

16. A computer readable storage medium storing a program to be executed by a computer, which when executed by a computer causes the computer to perform a method, the method comprising:
performing a list display in a list display area of the display unit and a preview display in a preview display area of the display unit;
receiving an amount of data for the preview display; and
determining a ratio of display sizes of the list display area to the preview display area based on the amount of data for the preview display.

17. The computer readable storage medium according to claim 8, the method further comprising:
storing at least on display parameter in a storage unit;
forming a display screen using the data for the preview display and the at least one display parameter; and wherein
the determining determines the ratio of the display sizes based on the formed display screen.

18. The computer readable storage medium according to claim 16, the method further comprising:
variably adjusting the determined ratio of display sizes when the amount of data for the preview display changes.

19. The computer readable storage medium according to claim 17, the method further comprising:
receiving an input changing the at least one stored display parameter; and
variably adjusting the determined ratio when the at least one stored display parameter changes.
